(19) United States
(12) Patent Application Publication
(10) Pub. No.: US 2008/0146147 A1
(43) Pub. Date: Jun. 19, 2008

(54) Methods and systems for retransmission of a broadcast signal using proximity transmitting radiator

(75) Inventor: Aric Jerome Streeter, South Lyon, MI (US)

Correspondence Address: KRAMER LEVIN NAFTALIS & FRANKEL LLP;INTELLECTUAL PROPERTY DEPARTMENT, 1177 AVENUE OF THE AMERICAS, NEW YORK, NY, 10036, US

(73) Assignee: Sirius Satellite Radio, Inc., New York, NY (US)

(21) Appl. No.: 11/891,558

(22) Filed: Aug. 10, 2007

Related U.S. Application Data
(60) Provisional application No. 60/837,337, filed on Aug. 10, 2006.

(51) Int. Cl. H04B 5/00

(52) U.S. Cl. 455/41.1

(57) ABSTRACT

Systems and methods for wireless transmission of a modulated audio signal to a receiver using near-field or proximity transmission are presented. In exemplary embodiments of the present invention, such systems and methods can receive a broadcast signal with a first receiver, generate an audio signal therefrom, and then use a modulation device to convert the audio signal into a modulated signal. The modulated signal can be retransmitted wirelessly via a radiating element. The radiating element can, for example, be placed in close proximity to a second receiver, thereby enhancing the wireless link from the modulation device to the second receiver, and allowing the radiating element to operate at a relatively low power. In exemplary embodiments of the present invention, the broadcast signal can be, for example, a satellite radio signal, and the retransmission can occur within a vehicle, the second receiver being, for example, an in-vehicle conventional AM/FM radio system. In exemplary embodiments of the present invention, the radiating element can be remote from the first receiver, and can be co-located or integrated with the modulating device in a remote location. In exemplary embodiments of the present invention, a digital to analog converter can also be collocated, in-line with, or integrated with the modulating device and radiating element in the remote location.

### CROSS-REFERENCE TO RELATED APPLICATIONS

This application claims the benefit of U.S. Provisional Patent Application No. 60/837,337, filed on Aug. 10, 2006.

### TECHNICAL FIELD

The present invention relates to wireless retransmission of broadcast signals. In particular, the present invention relates to systems and methods for enabling efficient wireless transmission of a modulated audio signal to a receiver unit using a near-field or proximity transmitting radiator.

### BACKGROUND INFORMATION

Satellite radio provides digital quality radio broadcast services covering the entire continental United States. These services can provide over 100 channels offering news, sports, talk and other programming. The Federal Communications Commission has (FCC) granted two national satellite radio broadcast licenses, allocating 25 megahertz (MHZ) of the electromagnetic spectrum for satellite digital broadcasting, 12.5 MHz of which are owned by the assignee of the present application, Sirius Satellite Radio, Inc. (“Sirius”).

Sirius' satellite radio service presently includes transmission of substantially the same program content from two or more geosynchronous or geostationary satellites to both mobile and fixed receivers on the ground. In urban canyons and other high population density areas with limited line-of-sight (LOS) satellite coverage, terrestrial repeaters are used to broadcast the same program content in order to improve coverage reliability. Some mobile receivers can simultaneously receive signals from two satellites and one terrestrial repeater for combined spatial, frequency and time diversity, which can provide for significant mitigation of multi-path interference and can also addresses reception issues associated with blockage of the satellite signals.

In addition to satellite radio, digital radio is available from conventional analog radio broadcasters and provides a terrestrial based system using signals located in the amplitude modulated (AM) or frequency modulated (FM) or Hi-Definition (HD)/In Band On Channel (IBOC) bands.

Additionally, recent developments in consumer electronics have increasingly focused on remote client devices, such as, for example, multimedia players and receivers that are portable yet also provide a high quality of reception. Accompanying the development of such portable devices has been the development of various technologies for integrating those portable devices with existing audio systems, such as, for example, in-vehicle audio systems. That is, consumers often are interested in using their preferred portable device with various existing audio systems.

For example, satellite radio receivers, such as Sirius' Sportster or S50 receivers, for example, or multimedia players, such as, for example, Apple's iPod, are capable of rebroadcasting a signal to a conventional in-vehicle radio receiver with the aid of conventional modulators and radiators (antennas). Such rebroadcasting is typically accomplished by providing the portable device with an internal or external radiating antenna system. For example, the portable device can use an internal radiator (antenna) or use cabling, such as a power cord or FM antenna cable, as a radiator to output a frequency modulated (FM) signal that can be received by the antenna of the vehicle's audio system and then played through the audio system. Typically, the rebroadcasted signal is on a frequency and utilizes a modulation method that is utilized in or supported by the vehicle audio system.

However, problems with transmission power levels can occur with existing rebroadcasting systems. In particular, radiated power levels which exceed FCC guidelines can occur with existing rebroadcast systems and can be particularly acute for equipment that rebroadcasts a signal into a conventional radio receiver such as an in-vehicle system. Therefore, in view of the desirability to integrate portable audio devices with existing audio systems, there is a need for systems and methods for effectively rebroadcasting data from a portable device to an in-vehicle system with reduced transmission power levels.

### SUMMARY OF THE INVENTION

Systems and methods for wireless transmission of a modulated audio signal to a receiver using near-field or proximity transmission are presented. In exemplary embodiments of the present invention, such systems and methods can receive a broadcast signal with a first receiver, generate an audio signal therefrom, and then use a modulation device to convert the audio signal into a modulated signal. The modulated signal can be retransmitted wirelessly via a radiating element. The radiating element can, for example, be placed in close proximity to a second receiver, thereby enhancing the wireless link from the modulation device to the second receiver, and allowing the radiating element to operate at a relatively low power. In exemplary embodiments of the present invention, the broadcast signal can be, for example, a satellite radio signal, and the retransmission can occur within a vehicle, the second receiver being, for example, an in-vehicle conventional AM/FM radio system. In exemplary embodiments of the present invention, the radiating element can be remote from the first receiver, and can be co-located or integrated with the modulating device in a remote location. In exemplary embodiments of the present invention, a digital to analog converter can also be collocated, in-line with, or integrated with the modulating device and radiating element in the remote location.

### BRIEF DESCRIPTION OF THE DRAWINGS

FIG. 1 depicts an exemplary system according to an exemplary embodiment of the present invention;

FIG. 2 depicts an exemplary signal path and signal processing configuration according to an exemplary embodiment of the present invention;

FIG. 3 depicts an alternative signal path and signal processing configuration according to an exemplary embodiment of the present invention;

FIG. 4 depicts an exemplary extender cable kit according to an exemplary embodiment of the present invention;

FIG. 5 depicts an exemplary FM extender cable according to an exemplary embodiment of the present invention;

FIG. 6 depicts an exemplary radiating cable according to an exemplary embodiment of the present invention;

FIG. 7 depicts an exemplary radiating cable mounted by suction cups according to an exemplary embodiment of the present invention; and

FIGS. 8A-8C depict various exemplary remote radiators according to exemplary embodiments of the present invention.

It is noted that the patent or application file may contain at least one drawing executed in color. If so, copies of this patent or patent application publication with such color drawings will be provided by the U.S. Patent Office upon request and payment of the necessary fee.

### DETAILED DESCRIPTION OF THE INVENTION

In exemplary embodiments of the present invention, a broadcast signal, such as, for example, a satellite radio signal or a signal form a multimedia player, can be received and processed to generate, for example, an audio signal. Where the audio signal is desired to be played using standard or pre-existing audio equipment, such signal can, for example, be retransmitted as a modulated signal and received using, for example, a conventional radio receiver. Such uses are contemplated when, for example, the broadcast signal is digital and the standard equipment desired to be used is an analog radio receiver located in a user's home or automobile. Such a retransmitted signal will sometimes be referred to herein as a “rebroadcast” signal.

It is noted that in exemplary embodiments of the present invention, a rebroadcast signal can be sent to existing audio equipment using any wireless communications format, such as, for example, AM, FM, HD, IBOC, or other modulation schemes as may be useful or desirable given the available existing audio equipment.

Because the power required to accurately transmit an exemplary rebroadcast signal relates to the proximity of the rebroadcast antenna to the receiving antenna of the existing audio equipment, by locating the rebroadcast antenna in close proximity to a receiving antenna, a lower output power of the rebroadcast antenna can be realized while achieving desired operation. In some contexts, lower power is actually required by applicable regulatory schemes, such as, for example, in the U.S. by the FCC, and even where it is not, a better signal to noise ratio for a given output power level can be achieved using systems and methods according to exemplary embodiments of the present invention.

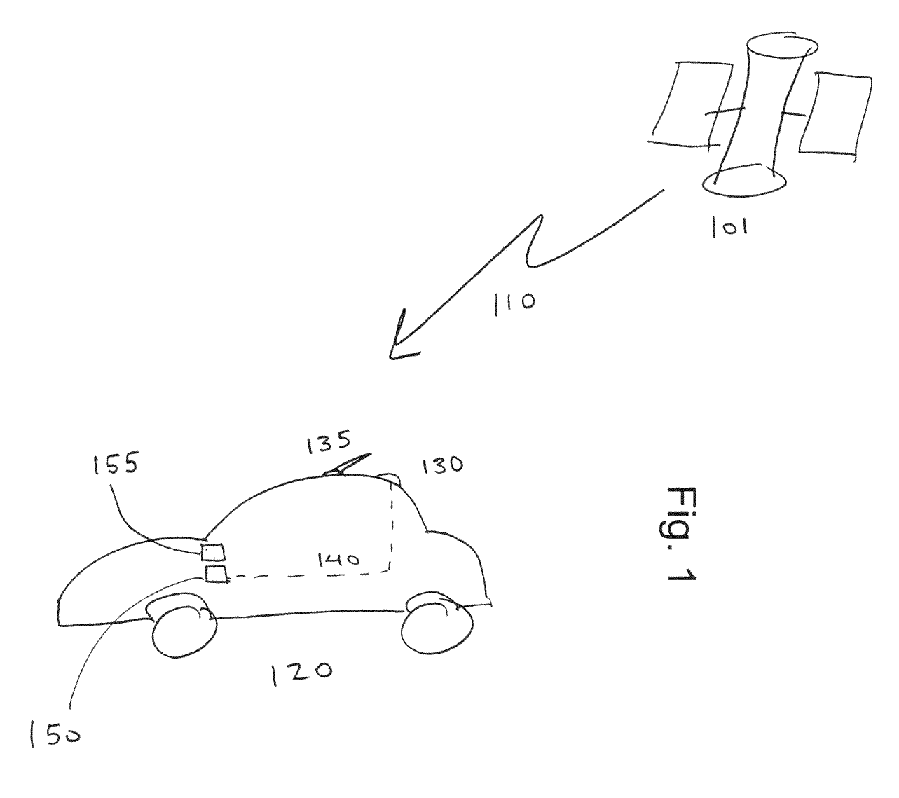

Next described is an exemplary system according to an exemplary embodiment of the present invention. FIG. 1 illustrates such an exemplary system. With reference thereto, the system comprises a satellite transmitter 101 which transmits a satellite broadcast signal 110. The satellite broadcast signal can be, for example, the SDARS digital satellite radio signal transmitted by assignee hereof, Sirius Satellite Radio, Inc. (whether broadcast by the satellite or terrestrial repeater portions of the Sirius system), that of XM Satellite Radio, or other signal. The broadcast signal 110 can be received, for example, in an automobile 120 provided with a satellite receiving antenna 130. The satellite broadcasting signal 110 as received by satellite antenna 130 can then, for example, be communicated as an electrical signal 140 within the vehicle to a satellite signal receiver 150. Besides satellite receiver 150, vehicle 120 can also, for example, be equipped with a standard AM/FM radio 155 and a corresponding conventional radio antenna 135. In the depicted exemplary automobile 120, antenna 135 is a stinger antenna. It is understood however, that antenna 135 can be any standard type of vehicle antenna, such as, for example, a whip antenna, an antenna imbedded in a windshield or window, such as, for example, either in front or back, or can be any other antenna of known shape or configuration.

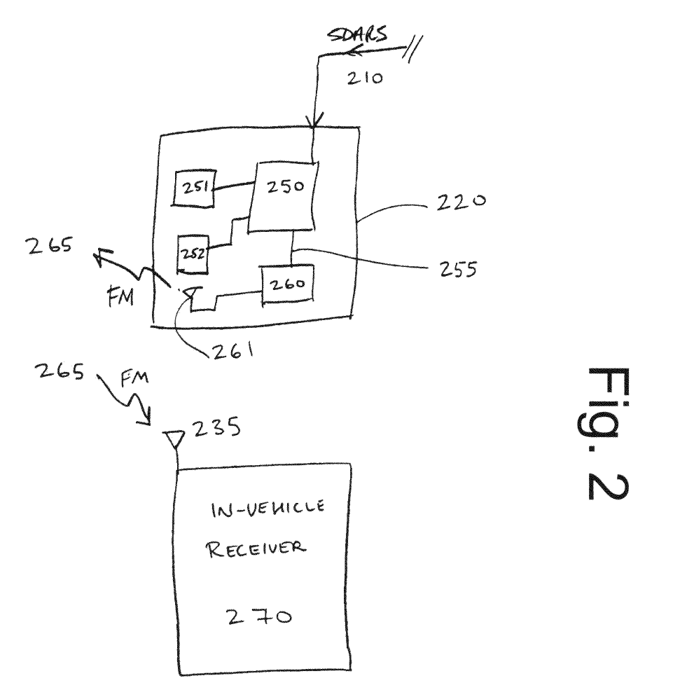

FIG. 2 depicts broadcast signal receiver 220 and conventional in-vehicle receiver 270 in greater detail. With reference thereto, a broadcast signal 210, such as, for example, the SDARS satellite radio signal, can be received via an antenna provided in a vehicle and communicated to a satellite receiver 220. Satellite receiver 220 can comprise, for example, chip set 250 which can output an audio signal 251 as well as a “PDT” or Program Descriptive Text signal for display, for example, on an integrated display. Audio signal 251 can be played through an integrated speaker, or, for example, if there is no integrated speaker, such signal can be retransmitted wirelessly so as to be received by a conventional in-vehicle receiver, as next described.

To support this functionality, satellite receiver chip set 250 can also can output an audio signal 255 which can, for example, be input to a conventional modulating device 260. Modulating device 260 can, for example, generate a conventional FM signal 265 via a rebroadcast antenna 261. Conventional FM signal 265 can thus contain the audio information received and processed from SDARS signal 210. Conventional FM signal 265 can then, for example, be received at receiving antenna 235, which is an antenna associated with in-vehicle conventional receiver 270. Antenna 235 can be, for example, stinger antenna 135 shown in FIG. 1. Once FM signal 265 is received at receiving antenna 235, it can, for example, be decoded and played through standard in-vehicle receiver 270.

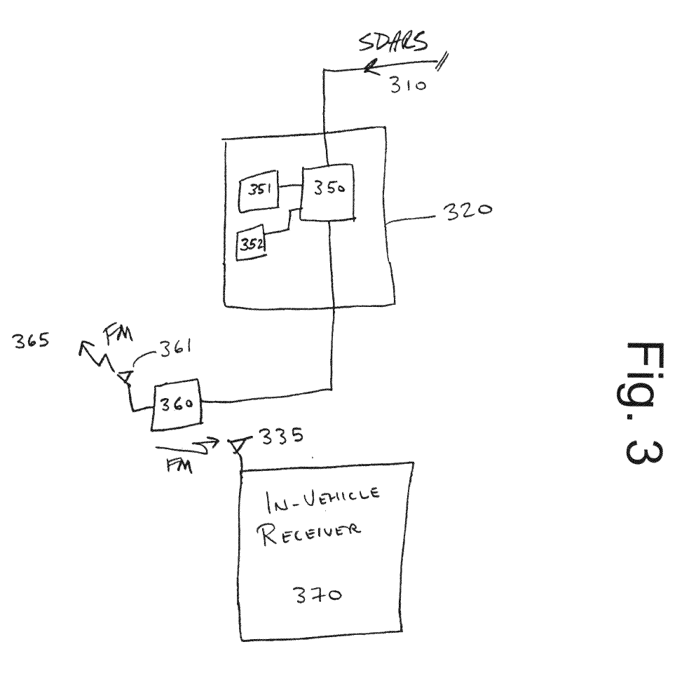

FIG. 3 depicts an alternate exemplary configuration for broadcast signal receiver 320, such as, for example an SDARS signal. SDARS signal 310 can, for example, be received and propagated to SDARS receiving apparatus 320. Broadcast receiver 320 is essentially identical to receiver 220 (shown in FIG. 2), except for the fact that modulation unit 360 in the exemplary system of FIG. 3 no longer integrated or co-located with the remainder of the SDARS receiving apparatus 320. Rather, in this exemplary configuration, modulating unit 360 can be co-located with radiating antenna 361 in a location which is remote from SDARS receiver apparatus 320.

Thus, in exemplary embodiments of the present invention, either rebroadcast antenna 361, or a combination of rebroadcast antenna 361 and modulation unit 360, can be located remote from the remainder of broadcast signal receiver 320 and in proximity to, abutting, or adjacent to, an in-vehicle receiving antenna 335, which can, for example, carry received FM signal 365 to in-vehicle receiver 370. By means of this arrangement, the proximity of rebroadcast antenna 361 to in-vehicle AM/FM radio antenna 335 can facilitate the use of lower transmission power than that of a system utilizing a rebroadcast antenna (i.e., a transmitting radiator) which is not in proximity to in-vehicle AM/FM radio antenna 335. In the example system depicted in FIG. 3, rebroadcast antenna 361 is located adjacent to receiving antenna 335.

Thus, in exemplary embodiments of the present invention, the proximity of transmitting radiator 361 to standard in-vehicle receiving antenna 335 can enable the use of lower transmission power than that of a conventional system using a transmitting radiator that is not in proximity to the receiver unit. In accordance with an exemplary embodiment of the present invention, the proximity of transmitting radiator 361 to conventional receiver antenna 365 results in an “electromagnetically large” radiator element which couples more effectively to the receiver unit antenna than would a radiator not in proximity to the receiver unit.

It is noted in this context that “electrically small” antennas are understood in the art to include rebroadcast antennas that are located at a distance of, for example, less than λ/10 from the receiving antenna, where λ is the wavelength associated with the transmission frequency of the rebroadcast signal. This is not a hard and fast rule, however, and can vary depending upon the source of the rebroadcast signal. In exemplary embodiments of the present invention, a radiating antenna can be in the range of, for example, a distance of λ/4 to λ/8 from the receiving antenna, but there can also, for example, be applications using λ/16 dipole antennas as well.

Exemplary embodiments of the present invention can, for example, be implemented in connection with a receiver capable of receiving the Sirius or XM satellite radio broadcasts. In such embodiments, a connection can be made, for example, to an “FM Out” port on the satellite signal receiver. Such connection can, for example, terminate with a radiator (rebroadcast antenna) located adjacent to the receiving antenna of a conventional in-vehicle radio. It can, for example, be tucked away under trim within the vehicle, or, for example, be affixed via an appropriate coupling mechanism (such as, for example, suction cup(s) or adhesive affixation means) in close proximity to the receiving antenna. Alternatively, a pure audio signal could be extracted from such a satellite signal receiver and transmitted via a connector to a combined or substantially co-located modulator and rebroadcast antenna that is located outside of the satellite radio receiver but in close proximity to the receiving antenna, as was depicted in the example system of FIG. 3. If the audio signal extracted from the receiver is a digital signal, for example, a digital to analog converter can, for example, also be located outside of the satellite receiver. Such a digital to analog converter can either be in line with, but not co-located with, a modulator and rebroadcast antenna, or it can be co-located with, or even, for example, integrated with, such a modulator and rebroadcast antenna, the remote unit thus comprising all three elements.

In exemplary embodiments of the present invention, the configuration of the radiating antenna can vary. Acceptable configurations can be, for example, any of a range of common antenna configurations of different mechanical construction, and can, for example, be both electrically loaded and un-loaded using standard methods. Examples of such configurations can include, for example, (i) a monopole antenna, which can be, for example, a fractional or non-fractional wavelength monopole; (ii) a dipole antenna, which can be, for example, a fractional or non-fractional wavelength dipole; (iii) a loop radiator antenna; (iv) a bent L antenna; or (v) a bent F antenna. Alternatively, in exemplary embodiments of the present invention, additional configurations can include, for example, any combination of these five antenna types in a multi-modal configuration or other conventional configuration.

As is known in the art, selection of a particular configuration for a rebroadcast antenna can be related to the placement of the rebroadcast antenna relative to the receiving antenna to achieve the desired low power yet effective transmission.

Alternatively, as is known in the art, instead of using a rebroadcast antenna, a suitable length of cable can operate as the radiating element. For example, a power cord can perform this function.

As noted above in connection with FIG. 3, practical applications for a transmitting radiator contemplated by exemplary embodiments of the present invention can include, for example, configurations whereby a broadcast signal receiver audio source unit (such as, for example, a receiver capable of receiving the Sirius SDARS broadcasts, or those of XM) that feeds a modulator and a rebroadcast transmitting radiator (antenna) are separated by a distance such that the broadcast signal receiver and the transmitting radiator do not both physically reside in the same location within the vehicle. In such exemplary embodiments, user control of the broadcast signal receiver is necessary for functioning of the system, but the in-vehicle unit antenna is in a different location within the vehicle.

Means by which an audio signal may be transferred from the source unit to the transmitting radiator can include, for example, a coaxial or other shielded cable running from the receiver which contains a modulator which modulates audio, and thus feeds a modulated audio signal to the transmitting radiator; a cable set carrying analog audio from the unit to a modulator that is close to, co-located with, or attached to the transmitting radiator; a cable set carrying digital audio from the receiver to an analog-to-digital converter to a modulator that is close to, co-located with, or attached to the transmitting radiator; and a cable set carrying encoded digital audio from the receiver to an audio decoder to an analog-to-digital converter and to the modulator attached to the transmitting radiator. Each one of the above configurations also may also include audio or radio frequency (RF) amplifiers, either analog or digital as may be appropriate, to adjust signal levels where appropriate. In addition, each one of the above configurations may use various methods to power any active circuitry in the signal chain, including, for example, on-cable direct current “bias” or “phantom” power or external direct current power interface.

An additional benefit of a transmitting radiator contemplated by exemplary embodiments of the present invention can be realized due to RF signal propagation as a result of proximity to the vehicle sheet metal structure. For example, placement of the transmitting radiator adjacent to the outer metal of a vehicle can result in a reduction of measurable emissions at a distance away from the transmitting radiator (i.e., the rebroadcast antenna), relative to those if the system, including the proximity transmitting radiator, were measured in “free space,” or outside of the vehicle.

### Exemplary Areas of Proximity

In exemplary embodiments of the present invention, a radiating antenna can be placed within the “Reactive Near-field” of a receiving antenna, which is understood by those skilled in the art, for example, as a condition of <0.62*sqrt{D³/λ}, where D is the largest dimension of the antenna, and A is the RF frequency wavelength.

For a rebroadcast antenna, assuming placement no greater then ¼λ from the receiving antenna (such as may be done for a FM signal, for example) or about 0.78 m, with λ equal to between about 2.78 and 3.41 m (average 3.1 m) for FM (88 to 108 MHz). These values gives a Reactive Near-field distance of:

<0.62*sqrt{0.78³/3.1}=0.24 m or 9.44 inches.

Or, for example, some broadcast antennas could be ⅛λ from the receiving antenna, or about 0.39 m length, which would put the reactive near field distance at:

<0.62*sqrt{0.39³/3.1}=0.086 m, or 3.39 inches,

which can still bound various likely usage scenarios.

According to an exemplary embodiment of the present invention, a significant amount of expected usage will be within the “Fresnel Radiative Near-field”, which is understood by those skilled in the art as the region between the Reactive Near-field and the Fraunhofer Far-field, where the upper bound is defined as <2*(D²/λ), or <2*[(0.78)²/3.1]=0.39 m (=15.45 inches) for a ¼λ antenna, to <2*[(0.39)²/3.1]=0.098 m (=3.86 inches) for a ⅛λ antenna.

Alternative exemplary embodiments of the present invention can, for example, include placement at distances that are greater than the Fresnel Radiative Near-field as well, although these are expected to be less common, inasmuch as the expected performance may be less than that desired by certain users.

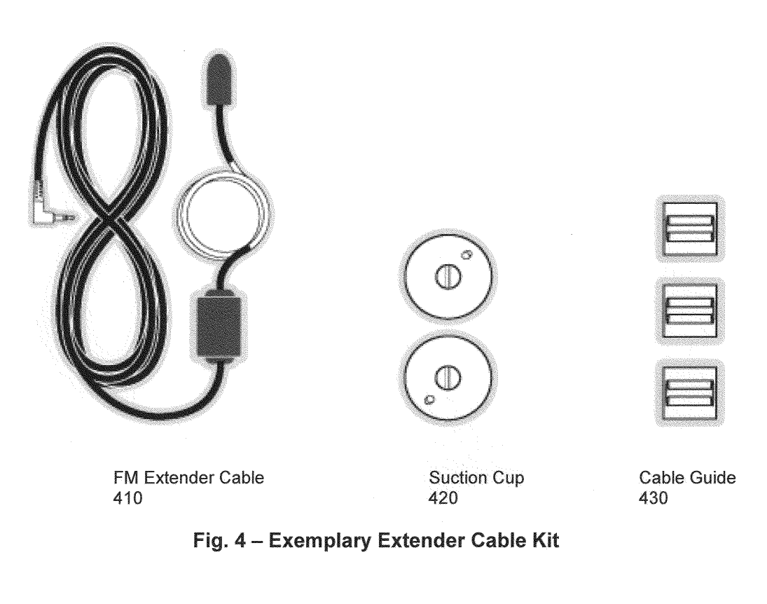

FIG. 4 depicts an exemplary extender cable kit that can be used in connection with exemplary embodiments of the present invention. The exemplary kit includes an FM extender cable 410, two suction cups 420 for adhering to, for example, the windshields, A-pillar or windows of a vehicle, as well as three cable guides 430.

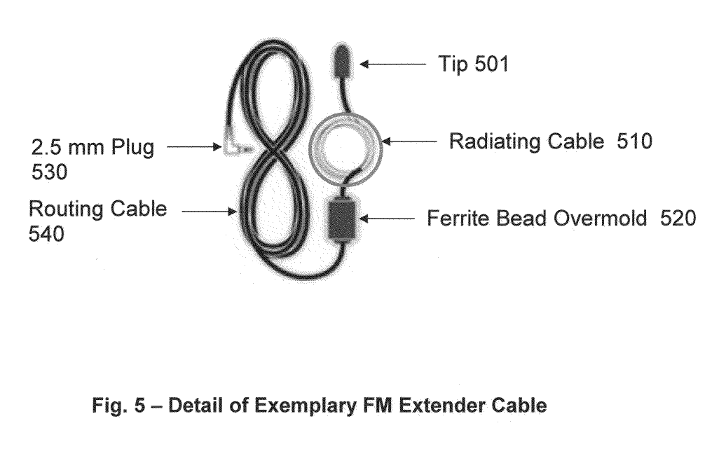

FIG. 5 depicts detail of an exemplary FM extender cable kit using a ⅛λ monopole radiator that can be affixed to, for example, the interior of a vehicle. A 2.5 mm plug 530 is provided which can connect to, for example, the “FM Out” jack of, for example, a Sirius radio, a vehicle dock for a Sirius radio, or another device generating a desirable signal and having an FM Out output. A routing cable 540 of approximately 18 feet in length can be used, for example, to connect 2.5 mm plug 530 to the remainder of the extender cable, including the radiator. In exemplary embodiments of the present invention, routing cable 540 can be, for example, a standard coaxial type of cable that has very low loss for FM frequencies. In the depicted exemplary configuration, the cable 540 can be black in color, can have a flexible jacket and can be as thin as, for example, the antenna cable used in connection with Sirius compatible after market car antennas.

A ferrite bead overmold 520 can be provided as well, connecting to the end of routing cable 540. Overmold 520 can, for example, house a ferrite bead, which can have an impedance of at least 150 ohms at 100 MHz frequency. The ferrite bead can have, for example, four turns of the coaxial cable (such as, for example, four times through the center with three wraps on top). One side of overmold 520 can, for example, be flat so that it can attach to a windshield, A-pillar or window of a vehicle. Thus, such flat side of overmold 520 can, for example, have 3M double sided tape to permanently adhere to the windshield, A-pillar or windows of the vehicle. Alternatively, other adhering means can be used as are known in the art. A radiating cable 510 can also be provided, a shown in FIG. 5, to retransmit the signal. Radiating cable 510 can be, for example, approximately 16 inches in length, acting as a FM antenna that couples with a vehicle's conventional FM antenna. The radiating cable 510 can be, for example, the center conductor of a coaxial cable with a jacket. Finally, tip 501 can be provided at the end of radiating cable 510. One side of tip 501 can be flat, and can have 3M type double sided tape, or other adhering means as may be known, so as to be attachable to the windshield, A-pillar or vehicle windows.

The above-described inline ferrite core can, for example, serve two purposes. First, the ferrite core can reduce the effects of unterminated standing wave radiation on the cable shield, which would otherwise act as a unintentional dipole. This can serve, for example, to reduce the amount of measurement inconsistency during FCC qualification testing. This can also allow for a more predictable measurement result, while allowing more energy to be sent to the proximity coupled radiator, thus providing a better user experience, while still passing the FCC requirements for emissions. Second, the ferrite core can serve as a counterpoise to a ⅛λ monopole radiator, which can thus allow for more predictable performance in the vehicle since the radiation is limited primarily to the monopole.

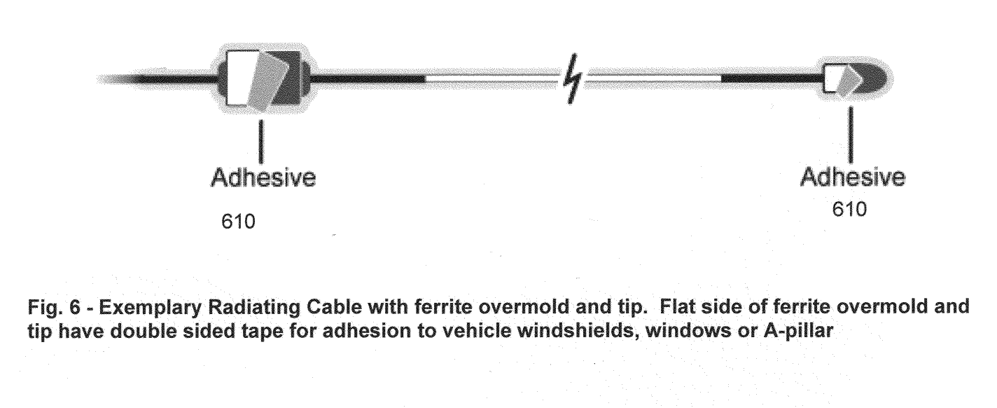

FIG. 6 depicts in greater detail an exemplary radiating cable with ferrite overmold and tip. The flat side of each of the ferrite overmold and tip can have 3M type double sided tape as an adhesive 610 for attaching to vehicle windshields, windows or A-pillar.

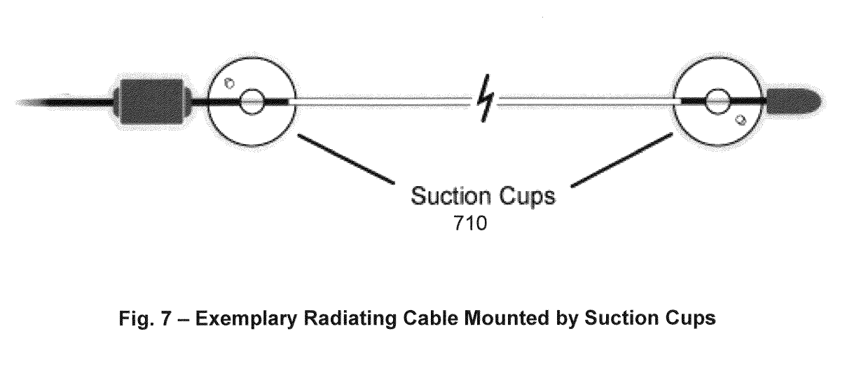

FIG. 7 depicts an exemplary radiating cable similar to that depicted in FIG. 6, but here mounted by suction cups 710 for a temporary affixation to a vehicle surface or surfaces. In this exemplary embodiment, suction cups 710 can be temporarily used to hold a radiating antenna to one or more vehicle surface(s). Suction cups 710 can be chosen, for example, so as to provide sufficient strength such that the radiating cable itself is held taut between the ferrite overmold and the tip. In such an exemplary embodiment, a user can mount the suction cups directly to the vehicle interior. Moreover, cable guides can also be provided, having double sided tape, which can be mounted to vehicle glass and used in the routing of an exemplary coaxial cable inside the vehicle.

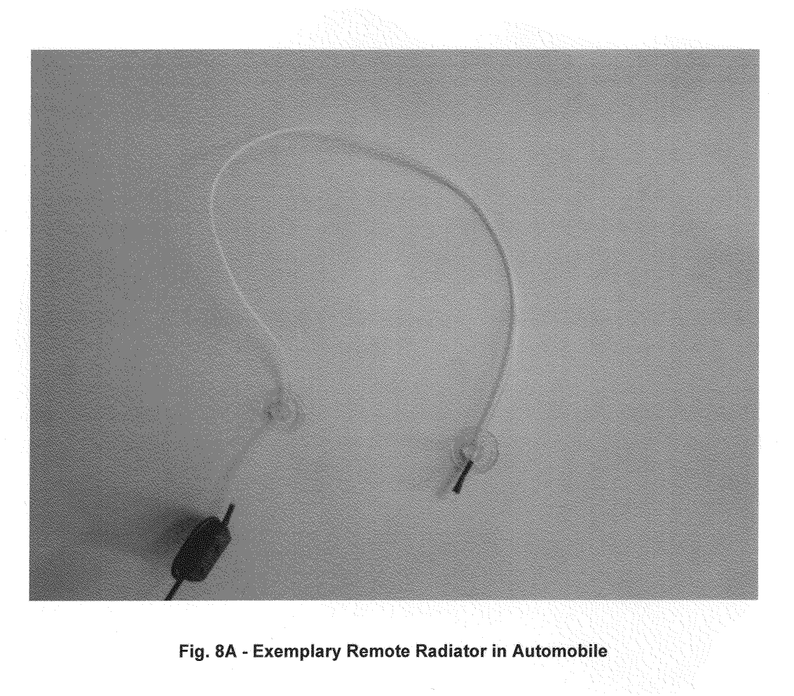

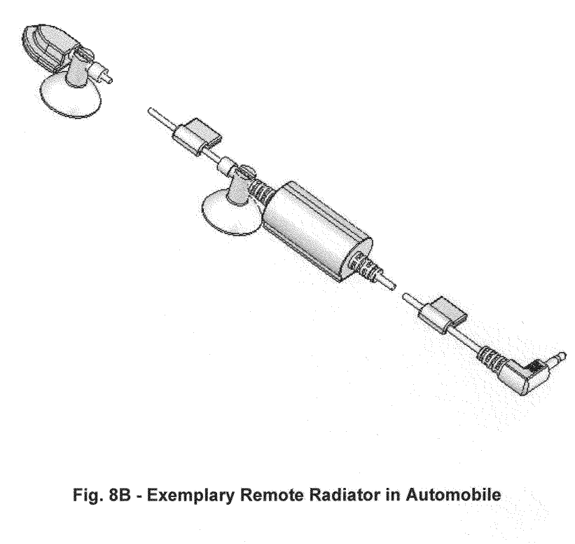

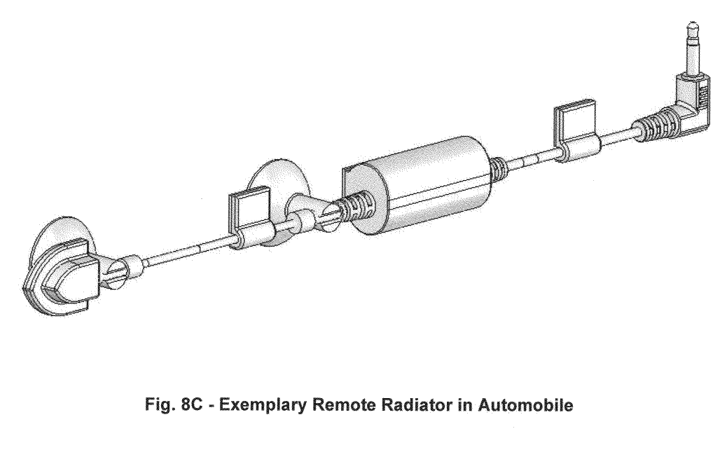

In exemplary embodiments of the present invention, antenna mounting options can include various mounting features, such as, for example, suction cups. FIG. 8A depicts an exemplary actual remote radiator of the type depicted in FIGS. 6 and 7, as deployed in an automobile, affixed by means of suction cups mounted at the functional ends of a ⅛λ monopole radiator that can attach to the vehicle glass.

FIGS. 8B and 8C depict various views of exemplary remote radiators in an automobile, attached to the vehicle interior via suction cups and cable guides as described above.

In alternative exemplary embodiments of the present invention hard cabling (such as, for example, RF, audio analog, or audio digital) can, for example, be replaced with a wireless link such as, for example, bluetooth, that functions by sending a decoded single audio channel to, for example, a remotely mounted modulator and proximity radiator, or, for example, any remotely mounted combination of A/D converters, modulators and proximity radiators, as described above.

While the present invention has been described with reference to certain exemplary embodiments, it will be understood by those skilled in the art that various changes may be made and equivalents may be substituted without departing from the scope of the invention. For example, exemplary embodiments of the present invention can be applied to the wireless FM (or AM, HD, or IBOC) modulation of signals from any source, such as, for example, iPODs, MP3 players, and any other devices or apparati whose signals may be desirable to obtain and play through an FM receiver. The signals to be modulated can be modulated at or near their original source unit, or remote therefrom, can be digital or analog, and can utilize various types of radiatoing antennae, all as described above, and all being within the scope of the present invention. In addition, many modifications may be made to adapt a particular situation or material to the teachings of the invention without departing from its scope. Therefore, it is understood that the invention not be limited to any particular embodiment, but that the invention will include all embodiments falling within the scope of the appended claims.

What is claimed:

1. A method for rebroadcasting an audio signal, comprising:
receiving a first signal;
processing the first signal to generate a second signal;
modulating the second signal to generate a rebroadcast signal;
transmitting the rebroadcast signal from a rebroadcast antenna, wherein the rebroadcast antenna is located in close proximity to a receiving antenna.

2. The method of claim 1, wherein the first signal is a SDARS signal.

3. The method of claim 1, wherein the first signal is an in-band on channel signal.

4. The method of claim 1, wherein the second signal is an audio signal.

5. The method of claim 1, wherein the audio signal is an analog signal.

6. The method of claim 4, wherein the audio signal is a digital signal.

7. The method of claim 1, wherein the rebroadcast signal is a frequency modulated signal.

8. The method of claim 1, wherein the rebroadcast signal is an amplitude modulated signal.

9. The method of claim 1, wherein the rebroadcast signal is an in-band on channel modulated signal.

10. The method of claim 1, wherein the modulating takes places within a receiver processing the first signal.

11. The method of claim 1, wherein the modulating takes place external to a receiver processing the first signal.

12. The method of claim 1, wherein the rebroadcast antenna is located within a receiver processing the first signal.

13. The method of claim 1, wherein the rebroadcast antenna is located external to a receiver processing the first signal.

14. The method of claim 1, wherein the rebroadcast antenna is one of a wavelength monopole antenna, a wavelength dipole antenna, a loop radiator antenna, a bent L radiator antenna and a bent F radiator antenna.

15. The method of claim 1, wherein the receiving antenna is coupled to one of an in-vehicle or in-home audio system.

16. The method of claim 15, wherein the in-vehicle audio system includes one of an automobile audio system, a truck audio system, a marine audio system, an aircraft audio system and a motorcycle audio system.

17. The method of claim 15, wherein the receiving antenna includes one of a whip antenna, a stinger antenna and an in-glass antenna.

18. The method of claim 1, wherein the rebroadcast antenna is located adjacent to the receiving antenna.

19. The method of claim 1, wherein the rebroadcast antenna appears electromagnetically large to the receiving antenna.

20. The method of claim 1, wherein the rebroadcast antenna is in the near field of the receiving antenna.

21. The method of claim 1, wherein the rebroadcast antenna is in the Reactive Near-field of the receiving antenna.

22. The method of claim 1, wherein the rebroadcast antenna is within the Fresnel Radiative Near-field of the receiving antenna.

23. The method of claim 1, wherein the rebroadcast antenna is about 3 inches from the receiving antenna.

24. The method of claim 1, wherein the rebroadcast antenna is about 9 inches from the receiving antenna.

25. The method of claim 1, wherein the rebroadcast antenna is about 15 inches from the receiving antenna.

26. The method of claim 1, wherein the rebroadcast antenna is at a distance approximately from ¼ to ⅛ of the transmitted wavelength from the receiving antenna.

27. The method of claim 1, wherein the rebroadcast antenna is located adjacent to a sheet metal structure of a vehicle.

28. The method of claim 27, wherein the sheet metal structure is the outer sheet metal structure of the vehicle.

29. The method of claim 1, wherein the rebroadcast signal is coupled to the rebroadcast antenna by shielded coaxial cable.

30. The method of claim 1, wherein the rebroadcast signal is coupled to the rebroadcast antenna by at least one of an audio cable, a digital audio cable, an analog audio cable, and a wireless link.

31. The method of claim 30, wherein the audio cable includes a two wire pair.

32. A system for rebroadcasting an audio signal, comprising:
a receiver receiving a first signal and processing the first signal to generate a second signal;
a modulator coupled to the receiver, the modulator processing the second signal to generate a rebroadcast signal; and
a rebroadcast antenna coupled to the modulator, the rebroadcast antenna transmitting the rebroadcast signal,
wherein the rebroadcast antenna is located in close proximity to a receiving antenna.

33. The system of claim 32, wherein the first signal is a satellite radio signal.

34. The system of claim 32, wherein the first signal is an in-band on channel signal.

35. The system of claim 32, wherein the second signal is an audio signal.

36. The system of claim 35, wherein the audio signal is an analog signal.

37. The system of claim 35, wherein the audio signal is a digital signal.

38. The system of claim 32, wherein the rebroadcast signal is a frequency modulated signal.

39. The system of claim 32, wherein the rebroadcast signal is an amplitude modulated signal.

40. The system of claim 32, wherein the rebroadcast signal is an in-band on channel modulated signal.

41. The system of claim 32, wherein the modulating takes places within a receiver processing the first signal.

42. The system of claim 32, wherein the modulating takes place external to a receiver processing the first signal.

43. The system of claim 32, wherein the rebroadcast antenna is located within a receiver processing the first signal.

44. The system of claim 32, wherein the rebroadcast antenna is located external to a receiver processing the first signal.

45. The system of claim 32, wherein the rebroadcast antenna is one of a wavelength monopole antenna, a wavelength dipole antenna, a loop radiator antenna, a bent L radiator antenna, a bent F radiator antenna and any combination thereof.

46. The system of claim 32, wherein the receiving antenna is coupled to one of an in-vehicle or in-home audio system.

47. The system of claim 46, wherein the in-vehicle audio system includes one of an automobile audio system, a truck audio system, a marine audio system, an aircraft audio system and a motorcycle audio system.

48. The system of claim 46, wherein the receiving antenna includes one of a whip antenna, a stinger antenna and an in-glass antenna.

49. The system of claim 32, wherein the rebroadcast antenna is located adjacent to the receiving antenna.

50. The system of claim 32, wherein the rebroadcast antenna appears electromagnetically large to the receiving antenna.

51. The system of claim 32, wherein the rebroadcast antenna is in the near field of the receiving antenna.

52. The system of claim 32, wherein the rebroadcast antenna is in the Reactive Near-field of the receiving antenna.

53. The system of claim 32, wherein the rebroadcast antenna is within the Fresnel Radiative Near-field of the receiving antenna.

54. The system of claim 32, wherein the rebroadcast antenna is about 3 inches from the receiving antenna.

55. The system of claim 32, wherein the rebroadcast antenna is about 9 inches from the receiving antenna.

56. The system of claim 32, wherein the rebroadcast antenna is about 15 inches from the receiving antenna.

57. The system of claim 32, wherein the rebroadcast antenna is at a distance approximately from ¼ to ⅛ of the transmitted wavelength from the receiving antenna.

58. The system of claim 32, wherein the rebroadcast antenna is located adjacent to a sheet metal structure of a vehicle.

59. The system of claim 58, wherein the sheet metal structure is the outer sheet metal structure of the vehicle.

60. The system of claim 32, wherein the rebroadcast signal is coupled to the rebroadcast antenna by shielded coaxial cable.

61. The system of claim 32, wherein the rebroadcast signal is coupled to the rebroadcast antenna by an audio cable.

62. The system of claim 61, wherein the audio cable includes a two wire pair.

63. An FM extender cable kit comprising:
an FM extender cable;
two or more suction cups for affixing the extender cable to an automobile window, windshield, a-pillar or other surface; and
at least one cable guide.

64. The apparatus of claim 63, including a satellite radio receiver.

65. An FM extender cable, comprising:
an input plug;
a routing cable;
a ferrite bead overmold;
a radiating cable; and
a tip,
wherein the FM extender cable is used to radiate an audio signal to an FM antenna.

66. The FM extender cable of claim 65, wherein the radiating cable is placed so as to be within a defined distance of the FM receiving antenna.

67. The FM extender cable of claim 66, wherein said defined distance is one of the Reactive Near-field and the Fresnel Radiative Near-field.

68. The FM extender cable of claim 65, wherein the radiating cable is one of a ¼λ monopole and a ⅛λ monopole.
